(19) United States
(12) Patent Application Publication
(10) Pub. No.: US 2006/0011898 A1
(43) Pub. Date: Jan. 19, 2006

(54) Neutral-color gray photochromic synthetic resin article

(75) Inventors: Manfred Melzig, Wessling (DE); Udo Weigand, Muenchen (DE); Claudia Mann, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Rodenstock GmbH, Muenchen (DE)

(21) Appl. No.: 11/206,088

(22) Filed: Aug. 18, 2005

Related U.S. Application Data
(63) Continuation of application No. PCT/EP04/01480, filed on Feb. 17, 2004.

(30) Foreign Application Priority Data
Feb. 19, 2003 (DE) 103 07 121.0

(51) Int. Cl. G02B 5/23; G02F 1/361

(52) U.S. Cl. 252/586

(57) ABSTRACT

A neutral-color gray photochromic synthetic resin article which remains almost completely color-neutral or gray both during darkening as well as during fade. The synthetic resin article according to the invention may be employed as a neutral-color gray photochromic ophthalmic lens.

### CROSS REFERENCE TO RELATED APPLICATIONS

This application is a continuation of international application no. PCT/EP2004/001480, filed Feb. 17, 2004, designating the United States of America, and published in German on Sep. 2, 2004 as WO 2004/074883, the entire disclosure of which is incorporated herein by reference. Priority is claimed based on Federal Republic of Germany patent application no. DE 103 07 121.0, filed Feb. 19, 2003.

### BACKGROUND OF THE INVENTION

The present invention related to a neutral-color gray photochromic synthetic resin article which remains almost completely color-neutral or gray during both darkening and fade. The synthetic resin article according to the invention may in particular be used as a neutral-color gray photochromic ophthalmic lens.

Photochromic synthetic resin products, especially ophthalmic lenses have been on the market since the '80s. The first lenses to find a wider distribution, e.g., the Rodenstock Perfalit Colormatic (since 1986) or the tinted Transitions lens from Transitions Optical Inc. (since 1990), which is offered by a number of lens manufacturers, contained spiro-oxazines as the photochromic dyes which darkened in blue hues. Upon moderate excitation, this, combined with the brownish pre-coloration of the lens, produced an approximately gray color. Later products such as the “gray” Transitions Plus lens (since 1992), or the brown Transitions Eurobraun and Hoya Sunbrown lenses (since 1994), or the Rodenstock Glas [lens] Perfalit Colormatic neu [new] (since 1995) contained pyrans as well as spiro-oxazines and/or fulgides. Subsequent products, such as the Transitions III lens, preferably use pyrans, especially naphthopyrans, and the larger ring systems derived from these. Of these, the Transitions III products with their refractive index of 1.56 are based on U.S. Pat. No. 5,753,146. Products currently available commercially, such as the Hoya Sungray IV or Sunbrown IV, Rodenstock ColorMatic Extra and Transition Next Generation, which are both also available in gray and brown, utilize mixtures of different photochromic pyrans.

Various color systems have been developed and defined for objectively characterizing colors. The most widely known and most suited to ophthalmic lenses is the L*a*b* or CIELAB color system (1976), in which the brightness (L*) and the color (a*, b*) can be represented by a point within a sphere. During its darkening and fade processes, a photochromic lens may be described by a continuous set of points, i.e., a curve in three-dimensional space. The principal factor in assessing the transmittance color of an ophthalmic lens is the projection of this curve onto a central plane, which is expressed by the a* and b* values. The system here is equidistant, i.e., equal color distances in the system correspond to equal color differences.

In this color space, a lens which remains at the zero point with respect to a* and b* during the darkening and fade cycle, i.e., which moves only along the L* axis, represents the ideal case for a neutral-color lens. Theoretically it passes from white (=colorless, since a lens, especially an ophthalmic lens, is observed in transmittance, not reflection) through all gray tones to black, i.e., to complete opacity. In all cases, the lens is absolutely neutral in color. Neither this mathematical target value nor the end points are absolutely attainable in reality, i.e., minor deviations from the zero point in the a*b* plane are unavoidable.

U.S. Pat. No. 5,753,146 relates to compositions comprising at least two photochromic naphthopyran compounds, which are free of amino-substituted aryl groups on the carbon atom vicinal to the oxygen atom of the pyran ring. When introduced into an appropriate carrier and exposed to ultraviolet sunlight, these compositions in the activated state are intended to have a gray or brown neutral color contained within the a* and b* ranges from +10 to −10 of the CIELAB color system. Measurements of the lenses described as prior art in U.S. Pat. No. 5,753,146 have shown that their color locus in the darkened state is a*≈+8 and b*≈+4. During the fade phase, the values even reach a*≈+12 and b≈+14. For the chroma C* which is defined as the root of the sum of the squares of a* and b* and characterizes the deviation from the ideal gray point, values are found in the darkened state measuring C*≈9.0, and in the extreme case measuring up to C*≈18.8. As a result, one can no longer speak in terms of a color-neutral lens; rather, the strong color shift during darkening and fade results in an effect which is characterized as the “chameleon effect.” Thus the lenses described in U.S. Pat. No. 5,753,146 as photochromic “gray” lenses, as well as other available lenses of prior art, move a considerable distance during darkening and fade from the zero point. To be sure, based on measures described in U.S. Pat. No. 5,753,146, the color loci of lenses in question could be limited to smaller values. The C* value was halved to 9.26; however almost the entire color curve is found in the green-blue color quadrant. The remaining high chroma value as well as the blue-dominated color curve are thus still far from the ideal of a neutral-color gray lens.

Published international application no. WO 00/29877 described for the first time a neutral-color gray photochromic synthetic resin article which remains almost completely neutral in color both during darkening and during fade, i.e., it remains gray. The neutral-color gray photochromic synthetic resin article described in WO 00/29877 has at least two different photochromic color centers incorporated into it, said centers being selected from the class of benzopyrans and higher annellated ring systems derived therefrom and characterized in that it only runs through only color loci for a chroma of C*<8, preferably C*<6, more preferably C*<5, during a 15-minute exposure to 50 klux at 23° C. according to DIN EN ISO 8980 and a 15-minute fade in the dark.

The problems with such an embodiment having at least two photochromic color centers or colorants are also described in WO 00/29877. They include the varying spectral composition of the exciting light which depends on the geographic location and the season and time of day, differences in temperature characteristics and the individual long-term stability of the colorants used.

The color locus of a photochromic synthetic resin lens containing more than one photochromic colorant also depends on the spectral composition of the exciting light. This is true not only in the excitation phase (direct sunlight or disperse light) but also in the fade phase for the residual light. Within the scope of the present invention, a standard that is independent of all eventualities pertaining to the measurement site, such as the season and time of day, geographic latitude, altitude, weather and climate conditions, etc., is used below. With the solar simulator described in DIN EN ISO 8980, it has been possible to achieve a fade that approximates natural conditions at various temperatures and with various lighting intensity. Analysis of the transmitted light using a diode array and computer processing (as described in greater detail in the technical part of the aforementioned standard) allows a determination of the transmittance and color locus every 3 seconds. Within the scope of the present invention, the color characteristic was observed over 15 minutes of darkening with 50 klux and a subsequent 15 minutes of fade in the dark at a standard temperature of 23° C.

### SUMMARY OF THE INVENTION

It is therefore an object of the present invention to provide an improved color-neutral gray photochromic synthetic resin article.

Another object of the present invention is to provide a color-neutral gray photochromic synthetic resin article which remains almost completely color neutral, i.e., gray, both during darkening as well as fade and which should be independent of spectral composition of the exciting light.

These and other objects are achieved in accordance with the present invention by providing a neutral-color gray photochromic synthetic resin article which is colored by containing only one photochromic dye selected from the class of benzopyrans and higher annellated ring systems derived therefrom, wherein the article passes through only those color loci whose chroma is C*<8 during a 15-minute exposure to 50 klux at 23° C. according to DIN EN ISO 8980 and a 15-minute fade period in the dark.

Specifically, a color-neutral or gray photochromic synthetic resin article is produced which contains only one photochromic dye selected from the class of benzopyrans and higher annellated ring systems derived therefrom, the article being characterized in that during a 15-minute exposure to 50 klux at 23° C. according to DIN EN ISO 8980 and a 15-minute fade in the dark, it passes through only color loci for which the chroma is C*<8.

According to the present invention, a neutral-color gray photochromic synthetic resin article is one whose color locus is constantly close to the zero point during the darkening and fade described here. Usually this material will run through two or more quadrants of the CIELAB color system. This ideally follows a straight line namely in one direction for darkening and in the opposite direction for fade, but in reality lines with a slight curvature are involved, both having the same direction of curvature in fade and darkening but not necessarily coinciding. Since the starting point is usually reached only through special measures (e.g., baking) and fade is not achieved again within 15 minutes at 23° C., the color locus is not usually completely shifted. The C* value is important for the neutral gray color. An inventive neutral-color gray photochromic synthetic resin article will preferably have a C* value of C*<8, more preferably C*<5.

The color locus in the fully darkened state after 15 minutes of exposure is especially important for wearers of ophthalmic lenses. This color locus is a quasi-steady-state, unlike the color loci during darkening and fade, i.e., over an extended period of time. In accordance with the present invention, the color-neutral, gray, photochromic synthetic resin article exhibits a color locus after a 15-minute exposure to 50 klux at 23° C. according to DIN EN ISO 8980, with a C* value of <5, preferably C*<4, especially preferably C*<3.

In another embodiment of the present invention, the spectral transmittance of the article according to the invention is preferably under 25%, more preferably under 20% in the range of 400 to 650 nm in the darkened state after a 15-minute exposure to 50 klux at 23° C. according to DIN EN ISO 8980. The spectral transmittance of the article according to the invention is preferably under 50% in the range of 700 nm in the darkened state after a 15-minute exposure to 50 klux at 23° C. according to DIN EN ISO 8980.

In order to obtain color-neutral, gray lenses, it is also important, however, that the transmittance in the central region of the visible range be as constant as possible. Thus the spectral transmittance difference in the range of 415 to 640 nm in the darkened state after a 15-minute exposure to 50 klux at 23° C. according to DIN EN ISO 8980 should, for example, be under 10%, more preferably under 8%.

In another embodiment, the spectral transmittance according to V_{□} in the completely deactivated state, given a 2 mm material thickness without antiglare measures, is above 80%. Photochromic lenses are all-purpose lenses; ideally they should replace both a clear lens as well as a sun-protective lens. The resulting requirement is for the highest transmittance possible when not excited by light, e.g., at night. Combined with antiglare measures, the aforementioned value allows for transmittance values approaching or at 90%.

The synthetic resin article according to the invention may be employed as an optical element such as a lens for which the refractive value measured at the Na-d line is between 1.49 and 1.76. In particular, the synthetic resin article according to the invention may be employed as an ophthalmic lens.

In principle, photochromic synthetic resin lenses may be produced in three different ways. First, the photochromic dyes may be dispersed homogeneously in the synthetic resin lens material. Alternatively, they may be introduced (usually only on the convex side) into the surface of the synthetic resin lens by diffusion using heat. Additionally, they can be applied as a layer on the synthetic resin lens. In the case of diffusion-pigmented lenses, additional problems may occur when using multiple photochromic colorants, because the diffusion rate and the depth of penetration of the colorant may differ significantly. Not only the type of plastic polymer used is important here but also the coloring time, the coloring temperature, the type of intermediate carrier used (lacquer) are important because even the polymerization conditions of the synthetic resin lens are important. When using only one photochromic colorant for coloring, as provided according to this invention, these influencing parameters for color, color constancy, etc. are no longer relevant.

It is known in general that a neutral color in an additive mixture is obtained by combining at least two colors. When only two colors are used, they should be approximately complementary, i.e., the absorptions of the photochromic colorants and/or the maximums in the visible spectral range must be connectable by a straight line passing through the “white field” in the UCS color table of the CIE 1976 for 2° and/or 10° normal observer. Thus in the case of only two colorants, this yields the result that the absorption maximum of one colorant is below approx. 495 nm while that of the other is above approx. 570 nm. Values of approx. 100 to 130 nm are thus obtained as the difference in the absorption maximums of possible combinations. This condition also applies to the same extent for synthetic resin articles containing only one photochromic colorant. All these requirements of such a colorant are also described in U.S. Pat. No. 6,392,043, in particular the advantage of uniform color in darkening and fade. When using only one colorant, the condition that the absorption maximums must have approximately the same intensity, whereas when using two or more colorants, an intensity difference can be compensated by the concentrations used, is also applicable.

WO 00/29877 also describes the advantages obtained from achieving the goal with only a single photochromic colorant. It is reported there that when “a colorant has several absorption bands in the visible of almost the same intensity, definitely covering the wavelength range from 420 nm to 580 nm, a neutral color lens is possible with just one photochromic colorant. This additionally has the advantage that all factors which have a negative effect on the neutral color during darkening and fade, e.g., differences in darkening and fade rates, are ruled out. In this case the color is not influenced by the temperature (no difference in temperature dependence) or the spectral composition of the exciting light (no difference in excitation spectra). The ideal solution for providing a neutral-color gray photochromic synthetic resin article would be a single photochromic colorant having the corresponding absorption properties. In addition to the advantages mentioned above, all the problems and measures mentioned below for coordinating the colorants would be eliminated. At the present time, however, there is no known single photochromic colorant having only one color center which even approximately has this property. To this extent, currently at least two photochromic color centers are always necessary. Within the scope of the present invention, however, the fact that the at least two color centers may be present in a single molecule in which these color centers are covalently bonded by spacer groups, e.g., alkyl chains, as described in DE 44 20 378, for example, is taken into account.”

Another advantage of a single photochromic colorant for coloring which is not mentioned in WO 00/29877 is that there is no color drift with aging (unavoidable with all organic colorants) due to a difference in aging rate. The absorption decreases uniformly in the entire spectral range if it is certain that the single colorant used does not have any absorption in the visible range in aging. The latter usually occurs in the short wavelength blue spectral range (“yellowing”).

Viewed physically, an ideal gray lens has an absorption which is constant over the entire visible spectral range from 380 nm to over 780 nm. However, based on the spectral light sensitivity of the human eye, this is not necessary from a physiological point of view. The ranges below 430 nm and chiefly above 680 nm are of secondary significance.

Various photochromic colorants, in particular pyrans, are now known which have two or more absorption bands in the visible spectral range. In all cases, however, the aforementioned condition of approximately equal absorption intensity is not met. With the pyrans mentioned as prior art in U.S. Pat. No. 6,392,043, the longer wavelength band has two-thirds the intensity of the shorter wavelength band. Furthermore the two absorption peaks of these bands are separated by only 80 nm and the longer wavelength absorption is below 550 nm, which rules out a neutral color impression because these colorants do not have any absorption in the red spectral range. The colorants claimed in U.S. Pat. No. 6,392,064 have correctly positioned absorption peaks, but the intensity of the short wavelength range of these colorants is 85% higher than that of the long wavelength range. With these colorants alone, it is possible to produce reddish brown lenses, but neutral-color gray lenses cannot be produced in this way. The same thing is also true according to the description of the pyrans described in U.S. Pat. No. 6,426,023. Repeat measurements for the examples revealed a 70% to 85% higher intensity of the short wavelength absorption maximum λ₁. The fact that gray lenses cannot be produced merely with the pyrans claimed in these two publications as well as with the pyrans described in U.S. Pat. No. 3,567,605, U.S. Pat. No. 3,627,690, U.S. Pat. No. 4,826,977, U.S. Pat. No. 5,200,116, U.S. Pat. No. 5,238,981, U.S. Pat. No. 5,411,679, U.S. Pat. No. 5,429,744, U.S. Pat. No. 5,431,344, U.S. Pat. No. 5,458,814, U.S. Pat. No. 5,645,767, U.S. Pat. No. 5,651,923, U.S. Pat. No. 5,698,141, U.S. Pat. No. 5,783,116, WO 96/14596 and WO 97/21698 is also described in the later WO 00/77005. The pyrans described there have a more rapid fade rate in comparison with those described in U.S. Pat. No. 6,392,043 and they also have a hypsochromic shift of the absorption in both the excited and unexcited states, which is responsible for the lower coloration, but the short wavelength absorption band of these pyrans is also much more intense than the long wavelength band. Together with the lower coverage of the red spectral range, neutral-color gray lenses cannot be produced with these pyrans alone. The compounds described in U.S. Pat. No. 6,210,608 must be divided into two groups, those having a simple structure (Example 1) and those having a benzoannellated naphthopyran structure (Examples 2 through 4). The former do not have enough absorption in the long wavelength range and the latter have a much more intense long wavelength absorption band than the short wavelength band. This is also true of the compounds disclosed in U.S. 2002/0197S62, which differ from the aforementioned by a benzoannellation instead of a 1,4-methylene bridge on the saturated six-member ring opposite the pyran ring. The long wavelength absorption which is by far dominant is responsible for the non-neutral color described here. The compounds of WO 00/18755 are far from having the desired neutral gray color impression. The 2H-naphtho[1,2-b]pyrans described there have ten direct substitution sites, with far more than 100 possible substituents being given for each. It would be impossible for those skilled in the art to investigate all possible compounds (more than 1020). Therefore, the examples from this publication have been used for comparison, especially since the title of this publication refers to “gray coloring photochromic fused pyrans.” The pyrans described in WO 98/28289 also have two absorption bands in the visible spectral range but, as stated on page 16 of that publication, they are suitable for producing gray or brown colors only when combined with complementary photochromic compounds.

According to the present invention, a photochromic synthetic resin article having only one photochromic colorant used for coloring is made available for the first time; this photochromic synthetic resin article remains almost completely neutral in color, i.e., in fact thoroughly gray during both darkening and fade phases. The present invention is based on taking into account specific selection parameters with regard to the substituents in the case of 2H-naphtho[1,2-b]pyrans regardless of whether they are attached to the naphthopyran basic structure by single bonds or double bonds or by condensation.

### BRIEF DESCRIPTION OF THE DRAWINGS

The invention will be described in further detail hereinafter with reference to illustrative examples depicted in the accompanying drawings, in which:

FIG. 1 shows the color locus curve in the a*-b* color space of the CIELAB system for a typical example according to the invention as compared with the color locus curve of Example 1 of WO 00/18755 during a 15-minute exposure to 50 klux at 23° C. according to DIN EN ISO 8980 and a 15-minute fade in the dark at 23° C., and

FIG. 2 shows the color locus curve in the a*-b* color space of the CIELAB system for a typical example according to the invention as compared with the color locus curve of Example 2 of WO 00/18755 during a 15-minute exposure to 50 klux at 23° C. according to DIN EN ISO 8980 and a 15-minute fade in the dark at 23° C.

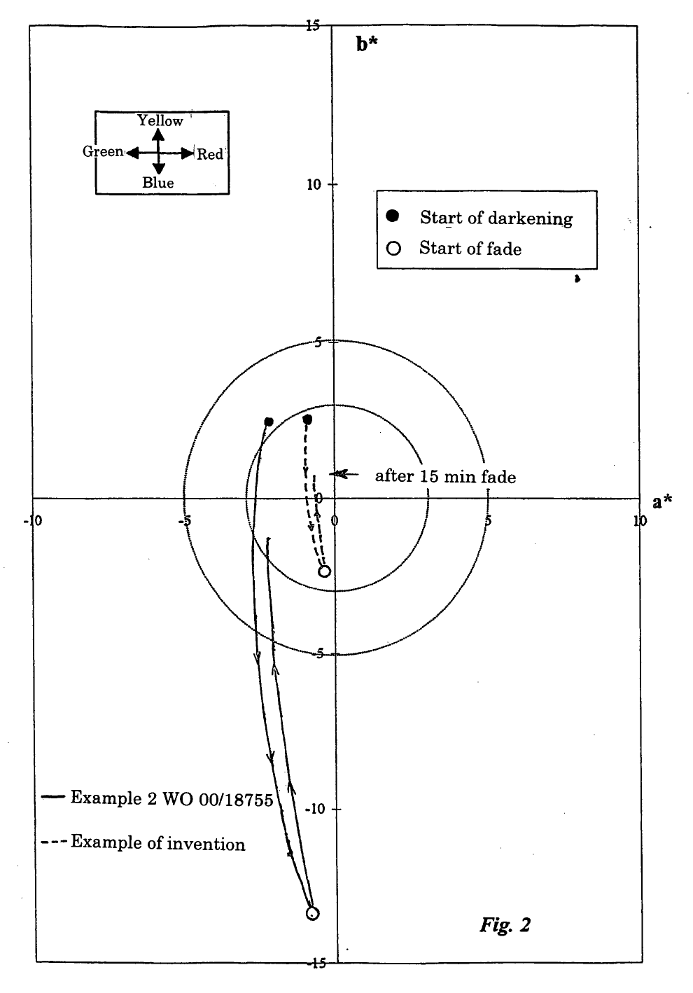

### DETAILED DESCRIPTION OF PREFERRED EMBODIMENTS

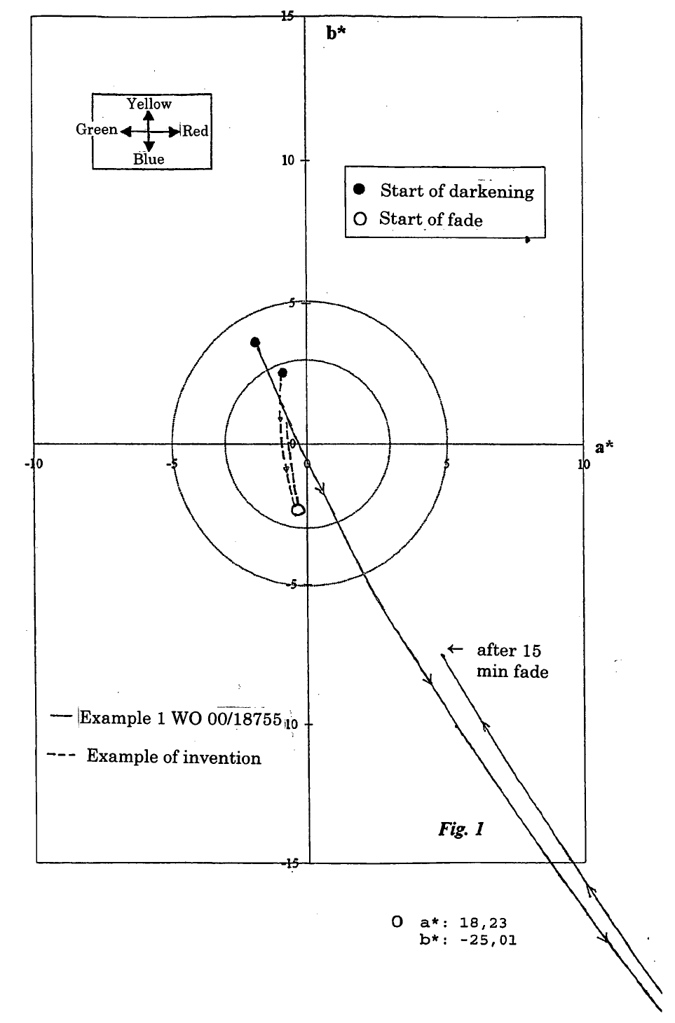

A neutral-color gray photochromic synthetic resin article according to the present invention has, for example, the spectral absorption (shown in FIG. 1) in the visible spectral range after 15 minutes of darkening with 50 klux at 23° C. according to the measurement procedure described in DIN EN ISO 8980. In the range of 420 nm to 620 nm, the spectral transmittance difference is less than 10%; this condition is met with a tolerance of the limits of ±10 nm even during darkening and for the first 15 minutes of fade.

The conditions of the neutral color impression in the fully darkened state are met in this way; as mentioned above, this is especially important for wearers of ophthalmic lenses because it is experienced as a quasi-steady-state condition, i.e., over an extended period of time.

It is possible to place the color locus in the fully darkened state at the zero point of the a*b* coordinate system, but a deviation is unavoidable for other color loci. However, such deviations are harmless, i.e., they are not perceived as color deviations even by a wearer of ophthalmic lenses who is trained in colors because the chroma C* and/or chroma difference C* amounts to approximately 1 or less. This is understandable inasmuch as the color states are seen in succession rather than in juxtaposition.

The chroma C* of the Comparison Example 1 in the completely darkened state is 30.9 (compare FIG. 1), that of the Comparison Example 2 is still 13.6, whereas the value for the example according to the invention is C*<3. Additionally, at no time during darkening and fade is a C* value of 5 exceeded.

The following discussion explains in detail the procedure for producing the neutral-color gray photochromic synthetic resin article according to the invention.

As the carrier or matrix for the photochromic dyes to be employed or used, the synthetic resin article according to the invention contains one or more synthetic resin materials. The synthetic resin materials used can be those synthetic resins normally used in prior art, especially for ophthalmic purposes. For example, the synthetic resin material may be selected from among: poly(C₁-C₁₂-alkyl) methacrylates, polyoxyalkylene methacrylates, polyalkoxyphenol methacrylates, cellulose acetate, cellulose triacetate, cellulose acetate propionate, cellulose acetate butyrate, polyvinyl acetate, polyvinyl alcohol, polyvinyl chloride, polyvinylidene chloride, polycarbonates, polyesters, polyurethanes, polyethylene terephthalate, polystyrene, poly-α-methylstyrene, polyvinyl butyrate, copoly(styrene-methyl methacrylate), copoly(styrene-acrylonitrile) and polymers of components of the group, consisting of polyol(allyl carbonate) monomers, polyfunctional acrylate, methacrylate or diethylene glycol dimethacrylate monomers, ethoxylated bisphenol-A-dimethyl acrylate monomers, diisopropenylbenzene monomers, ethylene glycol bismethacrylate monomers, poly(ethylene glycol) bismethacrylate monomers, ethoxylated phenol methacrylate monomers, alkoxylated polyalcohol acrylates, and diallylidene pentaerythritol monomers or mixtures thereof.

To produce the sample bodies, 500 ppm of each state-of-the-art compound and 500 ppm the compound of the present invention are placed in a mixture of acrylate monomers and 2 mm flat lenses are cast from them. A detailed description of the procedure is given in U.S. Pat. No. 6,225,466, which is incorporated herein by reference. The description in WO 99/15518 with regard to the samples and the measurement apparatus is also incorporated herein by reference.

The specimens were measured, as described in the experimental section of DIN EN ISO 8980, on a kinetics test bench. The measured light passing through the specimen should be capable of being analyzed in rapid sequence according to transmittance and color locus, e.g., using a diode array spectrometer. The result of this measurement is the color locus of the specimen before exposure and at any given time during the exposure and the fade phase. The latter generally occurs in the dark. Depending on the intended application of the synthetic resin article, this may also occur under standard illuminant A (incandescent light) or under attenuated exposure (shadow state). At minimum, a spectral analysis is performed before exposure, at the end of exposure and at the end of the measurement period, i.e., an absorption spectrum is recorded in the range of about 350 to 800 nm. The conditions for simulating natural exposure by sunlight, such as intensity and spectral distribution of the excitation light, are established in DIN EN ISO 8980; for ophthalmic lenses, a measurement temperature of 23° C. and an exposure intensity of 50 klux have proven appropriate. However, other temperatures and exposures are possible, depending on the later principal application of the synthetic resin article.

The compounds usable for the present invention all belong to the class of benzopyrans and higher annellated ring systems derived therefrom such as the naphthopyrans and fluorenopyrans. Aromatic or heteroaromatic substituted [3H]-naphtho(2,1-b)pyrans are preferred. Whereas the information or measures described in the prior art relating to the preparation of a gray synthetic resin lens still exhibit disadvantages or are in part insufficient or even misleading, the above-described method results in an article according to the invention, an actually neutral-color, gray, photochromic synthetic resin article which remains almost completely color-neutral or gray during darkening and also during fade. Any minor corrections are well within the technical competence of the average person skilled in the art.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A neutral-color gray photochromic synthetic resin article which is colored by containing only one photochromic dye selected from the class of benzopyrans and higher annellated ring systems derived therefrom, wherein the article passes through only those color loci whose chroma is C*<8 during a 15-minute exposure to 50 klux at 23° C. according to DIN EN ISO 8980 and a 15-minute fade period in the dark.

2. A synthetic resin article according to claim 1, wherein the chroma of the color loci is C*<5.

3. A synthetic resin article according to claim 1, wherein the color locus of the article has a C* value of <5 after a 15-minute exposure to 50 klux at 23° C. according to DIN EN ISO 8980.

4. A synthetic resin article according to claim 3, wherein the color locus has a C* value <3.

5. A synthetic resin article according to claim 1, wherein the article has spectral transmittance in the wavelength range from 400 to 650 nm of less than 25% in the darkened state after a 15-minute exposure to 50 klux at 23° C. according to DIN EN ISO 8980.

6. A synthetic resin article according to claim 1, wherein the article has a spectral transmittance at 700 nm of less than 60% in the darkened state after 15-minutes of exposure to 50 klux at 23° C. according to DIN EN ISO 8980.

7. A synthetic resin article according to claim 1, wherein the article has a spectral transmittance of greater than 80% according to V_{λ} in the deactivated state at a material thickness of 2 mm without antiglare measures.

8. A synthetic resin article according to claim 1, wherein said article is an ophthalmic lens.
